(19) United States
(12) Patent Application Publication
(10) Pub. No.: US 2008/0219820 A1
(43) Pub. Date: Sep. 11, 2008

(54) Work machine, preferably a wheeled loader

(76) Inventors: Christoph Kiegerl, Bischofshofen (AT); Leke Ukimeraj, Zell am See (AT); Markus Huber, Wagrain (AT)

Correspondence Address: DILWORTH & BARRESE, LLP, 333 EARLE OVINGTON BLVD., SUITE 702, UNIONDALE, NY, 11553, US

(21) Appl. No.: 12/011,080

(22) Filed: Jan. 24, 2008

(30) Foreign Application Priority Data
Jan. 25, 2007 (DE) UM20 2007000974.7
May 7, 2007 (DE) UM20 2007006501.9

(51) Int. Cl. B60P 1/04

(52) U.S. Cl. 414/469

(57) ABSTRACT

The present invention relates to a work machine, preferably a wheeled loader, having a bucket which is movable via lifting arms having at least one lift cylinder, on the one hand, and which is pivotable via a tilt mechanism actuable via at least one tilt cylinder, on the other hand, having a selectable fully automatic or semi-automatic bucket filling process in which the bucket is movable by a superimposition of the tilt movement of the bucket and of the lift movement of the lifting arm for the filling. In accordance with the invention, material-dependent target tilt cylinder speed values and target lift cylinder speed values stored in a memory are associated with the measured lift cylinder pressure values and/or the pulling force for the regulation of the bucket filling process.

### BACKGROUND OF THE INVENTION

The invention relates to a work machine, preferably a wheeled loader, and in particular to a control of the work equipment of a work machine for the purpose of an automated filling of the bucket.

The constantly increasing demands on construction machinery and construction equipment with respect to capacity, efficiency and damage minimization as well as increasing labor and payroll costs require a high qualification of the operating person for the optimum utilization of the capacity of the machines.

The automation of routines capable of repetition has in the meantime reached all areas of everyday commercial life and has achieved huge progress over the past few years in that complex functions and partial processes are broken down into standardizable functional portions capable of repetition in automation procedures.

In the meantime, suitable sensor systems are also available which deliver satisfactory signals during the total service life of the machinery despite high mechanical demands.

In the area of material handling, such as in the area of gravel pits or in the area of coal and steel, there is a demand with respect to a partial automation and a more long-term full automation of loading machinery since these applications are generally based on standardizable working routines and procedures.

A typical working routine of an excavating machine, which has been selected here as an example for a work machine, is explained with reference to FIG. 1. As is shown there, the loading sequence can be divided into the following partial processes:

(1) Driving up to the excavated material;
(2) Penetration of the work equipment, for example bucket, into the material;
(3) Bucket filling process;
(4) Reversing away from the excavated material;
(5) Driving to the unloading point and dumping; and
(6) Reversing away from the unloading point to the starting position.

The control of the machinery usually takes place manually by the operating person, with the pulling force or the torque being indirectly set using the gas pedal, whereupon some of the power of the diesel engine usually provided in the excavating machine is transferred rigidly via a hydrostatic transmission as well as an axle transfer case and cardan shafts to the front axle and the rear axle of the wheeled loader.

The movement routines of the work tool likewise take place by manual command signals in that the driver actuates the hydraulic cylinders via a joystick. The pump of the work hydraulics makes the required amount of hydraulic fluid available.

The hydraulic fluid is allocated to the hydraulic cylinders by the control block in accordance with the demands of the joystick.

The following takes place in the previously described partial processes:

In the first partial process, that is the driving up to the excavated material, the machine is driven to the excavated material by the operating person. During this phase, the work equipment is typically brought into the loading position, and indeed such that the bucket base or the lower edge was positioned approximately parallel to the ground. It is thus ensured that the shunting zone or the travel path is kept free of material. It should, however, be avoided in this process that the bucket digs into the subsoil, which would have the result of a ripping open of the travel path. The machine travel speed must be coordinated with the material to be loaded by the operating person. The difficulty for the unpracticed driver during this cycle consists of correctly positioning the work tool at the subsoil, with the starting position of the dumping kinematics being reached automatically via conventional limit switch devices.

In the second partial process, that is the penetration of the work tool into the excavated material, the operator first stabs into the material with the bucket, with this stabbing procedure typically taking place for so long until the material starts to dam up at the rear wall of the bucket. A stroke is intuitively generated by the operating person in this connection which has the result that the friction between the lower side of the bucket base and the material is reduced and the machine can penetrate further into the excavated material. Trials have shown that the friction at the lower side of the bucket has a high proportion in the penetration resistance. The recognition of that point at which a change is made from the penetration process into the actual bucket guiding process takes place intuitively by assessment of the operating person and is dependent on the material and on the material condition as well as on specific machine properties.

In the third partial process, the so-called bucket filling process, different movement routines of the bucket take place in dependence on the properties of the material to be loaded. On the one hand, with material which can be loaded very easily, such as sand or gravel, a single-step, so-called “separate” filing is possible which is characterized by a one-time penetration into the excavated material and a subsequent inward tilting without an additional lifting procedure. This type of filling can, however, only be used with reservations due to the limited pulling force. Usually, the different bulk materials are therefore loaded by means of a “multistep” or “combined” filling process. In this process, the excavated material is likewise first penetrated, with subsequently—in contrast to the previously described method—a superimposed, combined lifting and tilting movement of the work tool taking place. The penetration process is continued continuously in this connection. The control of these processes by the operating person is dependent on the material and on the material composition, with the degree of difficulty for the operator increasing as the grain sizes increase or as the grain distribution increases.

The degree of filling of the bucket, and thus the material handling performance of the loading sequence, is substantially determined by the quality of the bucket filling process. The difficulty for the operating person is, on the one hand, penetrating far enough into the material with the bucket and, on the other hand, carrying out the dosage of the subsequently superimposed lift and tilt commands by means of a joystick. Lifting movements which are too fast can cause a premature escaping of the bucket from the excavated material and impair the degree of bucket filling. Likewise, the operating person has to regulate the pulling force of the machine during the phase of the loading sequence in order to be able to ensure a filling of the bucket. The pulling force requirement is estimated by the operator and set indirectly by means of a foot pedal. Too low a set pulling force during the digging would have a negative effect on the degree of bucket filling, whereas with a high desired torque the machine sticks braced in the heap and little power is delivered to the work hydraulics. The energy required to maintain the torque cannot be utilized by the work hydraulics, while the digging process is subsequently carried out more slowly with little efficiency.

Furthermore, unnecessarily high torques in the drivetrain cause high damage portions at transmission and axis components which are responsible for wear and component failure, with the torque exerting an exponential influence on the component damage.

It can be recognized that not only the demand of achieving a high degree of bucket filling is made on the operating person; the operator must rather ensure the minimization of the mechanical load of the machine by adapting the manner of driving—in particular during the bucket filling process.

The bucket filling process thus makes the major demands on the operating person since this phase of the loading sequence represents a workstep which demands a high degree of concentration and experience from the operator.

In the fourth partial process, the reversing away from the excavated material, the bucket arm is brought into a position typical for driving operation after the end of the bucket filling process. To remove loose material from the bucket, it is absolutely customary to control a final brief outward and inward tilting before the reversing away. This impulse or this impulse sequence can in turn be dependent on the material and is at the discretion of the operator. Typically, to avoid oscillations of the bucket during driving operation, the bucket is clamped at the mechanical abutment to the bucket arm in that the tilt cylinder is acted on with pressure at the base side by means of a joystick command. The operator then reverses the machine so far back in reverse gear that the path to the unloading point can be taken in forward gear.

Finally, the last partial processes 5 and 6, namely the driving operation and the dumping must be mentioned for the sake of good order. After the change in the direction of travel, the machine is driven up to the unloading point by the operating person, for example a truck or a crusher. The lifting arm is controlled into the required unloading position and the bucket is emptied by means of a joystick command during this phase.

In particular the bucket filling process of work machines represents a partial process during a loading sequence which require a high degree of concentration and experience from the operating person to control the machine economically by satisfactory machine handling performance.

### SUMMARY OF THE INVENTION

It is therefore the object of the present invention to further develop a work machine known per se such that an automated filling of the bucket is made possible which guides the bucket through the excavated material without manual intervention of the operating person.

This object is solved in accordance with the invention by the features herein.

Preferred embodiments of the invention result from the description herein.

In accordance with the present invention, automatically correcting interventions in the drive of the work machine take place by means of a central control unit so that—based on measured machine parameters—the pulling force of the machine during the bucket filling process is regulated to a level—required for the loading—to minimize the load on the mechanical structure.

The integration of such a system thus provides a variety of advantages such as
the minimization of component damage by automatic correction of the pulling force or of the torque and, caused thereby,
the reduction of service and downtimes as well as
the minimization of fuel demand.

By a direct utilization by the operating person, the system is directed to
acting in a work-facilitating and work-assisting manner to prevent fatigue in the personnel during monotonous work processes and
facilitating or enabling the work procedure for untrained operators.

The automated bucket filling process can be integrated as a part module into the control of a completely autonomously operated, operator-free wheeled loader.

The bucket is admittedly moved by the operating person on a semi-automatic bucket filling process, but the movement procedure is controlled automatically in this context so that lift and tilt cylinder command settings and the pulling force setting are coordinated for the performance-optimized utilization of the hydraulic components.

The work machine can particularly advantageously have a sensor with which the material structure of the excavated material can be determined. These values which are taken up can be taken into account in the bucket filling.

### BRIEF DESCRIPTION OF THE DRAWINGS

Further details and advantages of the invention will be explained in more detail with reference to an embodiment shown in the drawing. There are shown:

FIG. 1: a schematic representation of the standard loading cycles of an excavator used as a work machine by way of example here;

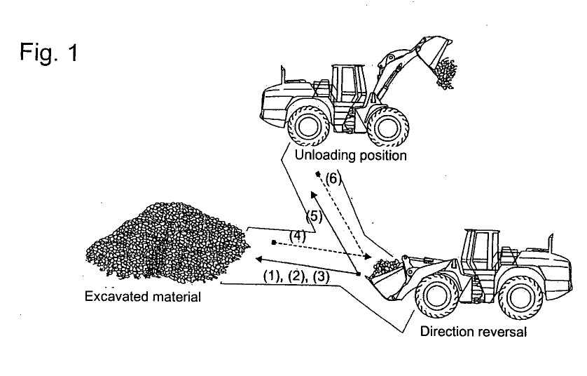

FIG. 2: a representation of a wheeled loader; and

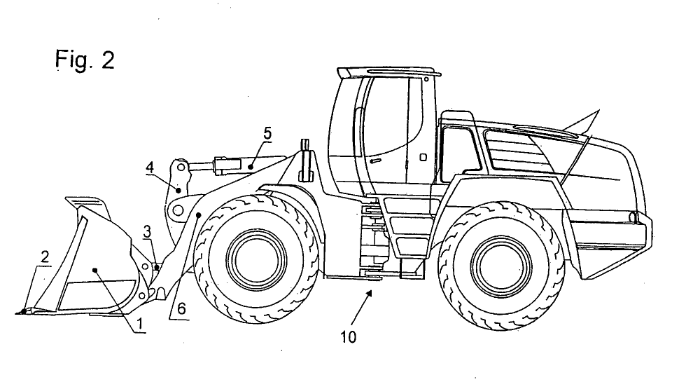

FIG. 3: the work equipment of the wheeled loader in accordance with FIG. 1 in detail.

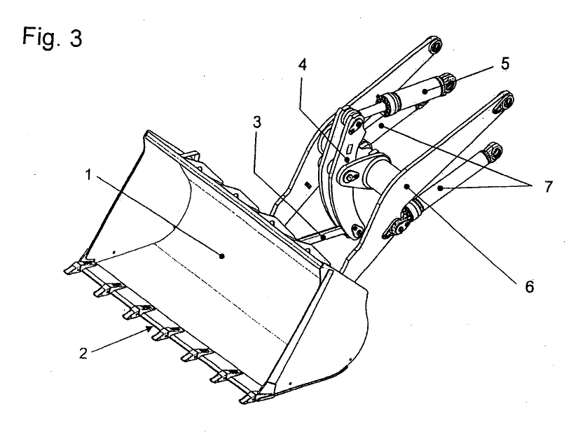

### DESCRIPTION OF THE PREFERRED EMBODIMENTS

The work equipment of a wheeled loader 10 consists of a bucket 1 with a ground blade 2 and a lifting arm 6 which is hinged in the front region of the machine and is moved by means of at least one lift cylinder 7. A tilt mechanism serves for the movement of the bucket and is moved with at least one tilt cylinder 5 and diverts the moving out movement into a rotary movement of the bucket by means of different components, e.g. 3 and 4.

In the example shown here, a wheeled loader is explained as a typical example for the excavator in accordance with the invention. Crawler-mounted loaders or telescopic handlers can, however, also be correspondingly designed instead of a wheeled loader. The following parameters are processed in the control for the automatic filling of the bucket:
machine travel speed and/or drivetrain speed which can be determined by means of commercial sensor systems, for example by means of a series speed sensor in the transmission,
drivetrain torque or pulling force,
hydraulic pressures in the lift and tilt cylinder and hydrostatic or power-split drive with a conventional pressure sensor system, for example based on membranes applied with strain gages,
position measurement system for determining the position of the work equipment.

The manual control of the work hydraulic system takes place by means of a central control unit, a CAN bus and input and output modules by actuation of a joystick in the operator's cabin by the operating person.

In order also to be able to intervene in the drive during the automated bucket filling procedure explained in more detail in the following, said drive is also controlled by a master with which a linking of driving hydraulic system and working hydraulic system can be ensured. It can be stated in this connection that the linking of driving and working hydraulic system should be made possible in accordance with an embodiment variant of the invention. This linking is, however, not absolutely necessary. The function of automatic digging is also made possible by a manual pulling force setting by the operating person. The underlying control algorithm of the invention with the corresponding regulation strategies can be broken down into a plurality of standardized functional portions which will be described as operating states in the following.

In the first operating state, the operating person actuates the automatic digging button on driving toward the excavated material. The characteristics of the material to be loaded can be previously selected, for example, via a further button, a knob, a touch screen or another interface.

The control changes into the automatic digging mode (operating state 1) provided that a plausibility query by monitoring of machine parameters allows it.

If these conditions do not apply, the requirements for a loading process are not given so that the automatic mode is deactivated.

A display, for example a combination of LEDs, visualizes that the machine is in an automatic mode, supported by an acoustic signal as soon as it is triggered. The pulling force setting takes place by the operating person, with the function not being able to be triggered or being deactivated at too high a machine travel speed.

The automatic mode is deactivated as a superimposed safety function by manual joystick intervention by the operating person.

As soon as the working equipment has been brought into the initialized position, the control changes into the next operating state.

In the second operating state, the wheeled loader is traveled up to the excavated material. While the machine continues to be controlled up to the excavated material, a routine monitors whether the bucket blade contacts the material.

In the third operating state, the bucket penetrates into the excavated material. The pulling force is either set manually by the operator by means of the foot pedal or—provided that the drive and the working hydraulic system work in a linked manner—automatically by the machine control. The torque setting by the foot pedal is reduced in that the maximum torque is corrected by the control. The operator can thus reduce the pulling force setting, but not over a calculated value.

An automatic lift command is generated during the penetration procedure to reduce the friction at the lower side of the bucket base and to make a better penetration possible.

That time at which the bucket has completely penetrated into the excavated material is fixed by monitoring the machine parameters.

The fourth operating state relates to the bucket filling process. The regulation strategy during the bucket filling process for the exertion of a combined movement procedure represents the major part of the automation of the bucket filling process. Conceptually, the pulling force should be reduced so far that an ideal effect of the lift cylinder is ensured. With a linked regulation of drive and working hydraulic system, the drive only makes that pulling force available which is necessary to move the wheeled loader further forward in a manner such that
sufficient power of the energy source, that is, for example, the diesel engine, or optionally also the electric motor is made available to the working hydraulic system to be able to use the lift and tilt cylinder force to the optimum,
the drive is operated as economically as possible, for example at a low diesel engine speed and
the component damage due to high torques is minimized.

Which material which is easy to load, the bucket filling movement is based on a slow inward tilting of the bucket or a superimposed lifting of the lifting arm until the loading process has been completed.

The measured data evaluation for different materials shows that as the grain size increases and as the grain size distribution becomes wider, the reproducibility of the loading processes decreases, whereby the continuity of the filling process also falls. The discontinuities which occur, such as large stones or blocks in the material, are taken into account in the regulation.

Whereas the control in the previous operating state, that is the penetration process, generates a lift command signal proportional to the lift cylinder pressure, the lift and tilt commands are superimposed in the bucket filling process. The strategy for the generation of the command signals required for this will be described in detail in the following:

The basis for the realizations are real, reproducible measurement cycles with a constant, ideal degree of bucket filling. The relationships of machine parameters which can be used for the regulation of the bucket movement during the digging process can be determined by means of evaluation routines.

An evaluation of corresponding measured data shows that the lift cylinder pressure can be used as the leading parameter for the control. In the embodiment shown in more detail here, however, the generation of the tilt command signals takes place in a regulating manner. After the evaluation of corresponding measured data, it was able to be shown that there is a relationship between the lift cylinder pressure and the tilt cylinder speed. It can be assumed in this connection that the lift cylinder pressure is proportional to the tilt cylinder speed. A measured lift cylinder pressure value can thus be associated with a material-dependent target tilt cylinder speed value for a regulation of the bucket movement during the bucket filling process. In comparison with systems of competitors, the system works in a regulating manner.

The desired value is constantly modified in the control on the basis of the lift cylinder pressure during this operating state and is compared with the actual value of the actual cylinder speed. A sequence control is present in a technical regulation aspect. The regulation difference and a suitable controller, for example a proportional controller, correspondingly generate electrical tilt command signals for the movement of the control slide in the hydraulic valve block which converts this command signal into a movement at the tilt cylinder for the filling of the bucket.

The corresponding association of lift cylinder pressure and target lift cylinder speed is stored in the central control unit either as a characteristic map or is described by means of an analytical relationship in the course of the function.

This relationship can be represented for rough gravel materials for a plurality of unchanging measurement cycles in the form of a frequency association, for example. A combination of frequency matrices which have been taken up allows the representation of the target tilt cylinder speed value as a characteristic map.

The lift cylinder pressure is in turn used as the leading parameter for the generation of the automatic lift command. A target cylinder speed is likewise associated with said lift cylinder pressure, in this case for the lift cylinder or cylinders.

Trials have shown that the lift cylinder pressure and the lift cylinder speed are inversely proportional in the application, from which it results overall that the lift and tilt commands can be generated inversely proportionally.

Analogously to the tilt command, a mathematically describable characteristic map can also be prepared on the basis of frequency matrices taken up and can be idealized by means of regression methods.

The electrical lift command signal is based on the difference between the desired value and the actual cylinder speed, generated by a suitable controller.

Inhomogeneities in the material of the excavated material can be recognized by means of the excavator of the invention.

As previously stated, the difficulty of the reproducible carrying out of the bucket filling process increases as the grain size increases. With large stones or blocks in the excavated material, it is not possible under certain circumstances to fill the bucket ideally. If, therefore, the lift cylinder pressure should fall very pronouncedly after a slight inward tilting of the bucket and if the bucket has not yet been lifted very far, a large stone can be expected in the excavated material. On the continuation of the standard routine, the bucket would break out of the material too prematurely, which would have the result of a poor degree of bucket filling. For this reason, the pulling force must first be reduced and the bucket must be emptied at a specific angle in order subsequently to return to the standard routine and to continue the bucket filling process.

Parallel to the bucket routine, the control monitors the cylinder paths as well as the lift cylinder pressure to determine the end of the bucket filling process.

It can be determined when the bucket breaks out of the excavated material and is filled by monitoring the lift cylinder pressure or its change over time. A check can furthermore be made of whether the cylinders moving out have reached a predetermined position. If the conditions apply, the control changes to the next following operating state (operating state 5), with which the bucket filling process is ended.

In the case of an operator-assisted system, the degree of bucket filling is evaluated by the operating person. The automatic mode can therefore be switched over here.

If the system is used as part of an autonomously working excavator, the determination of the degree of bucket filling—and thus the result of the bucket filling process—takes place by monitoring the-lift cylinder pressure via which a conclusion is made on the working load in dependence on the machine and equipment type.

In the event of negative feedback, the bucket filling process has to be repeated.

In order to avoid vibrations of the filled bucket, the bucket is now clamped at the mechanical abutment by the tilt cylinder, whereby excessive material loss on the traveling up to the unloading position can be prevented. The bucket reaches the abutment at the lifting arm by setting a final automatic tilt command signal.

By maintaining the tilt command over a predetermined duration, a high pressure is built up on the base side of the tilt cylinder and braces the bucket and lift structure and avoids a vibration of the bucket and material loss associated therewith.

In this operating state, the bucket can subsequently be tilted outwardly and inwardly again by a small angle to remove loose material before the clamping of the bucket at the abutment. This has the purpose of preventing a falling out of loose material on the travel path during the moving of the excavator.

The regulation of the drive is also deactivated at the end of the fully automatic or partly automatic function.

Provision can be made to be able to abort the automatic mode as an additional superimposed safety function. The function “automatic digging” can be ended at any time here by manual intervention by means of the joystick.

In accordance with an alternative embodiment of the invention, the option can also exist of allowing the operator a corrective intervention into the fully automatic movement development of the automatic digging by means of a joystick during the penetration process of the bucket into the excavated material and during the bucket filling process, with this command signal then having priority over the automatically generated one. A fast deactivation then has to take place via a different suitable interface.

In accordance with the invention, alternatively teaching can also take place in the form of material characteristics stored in the map by corresponding field trials of the excavator. The association of cylinder pressure and cylinder speed will thus also take place online in the excavator.

The operating person can set a separate mode (for example “teach mode”) for this online determination, whereby the recording process is started. The start of the bucket filling process is marked during the loading cycle, for example, by pressing a button. A plurality of pressure values and speed values which are classified by means of a frequency matrix are stored by the multiple repeating of this process. A specific loading characteristic can thus be directly associated with an unknown material (for example a rough-grain material) on site, with this teaching procedure not being absolutely necessary for the automated working routine. After picking up these values, the newly taught characteristic for the lift and tilt cylinder speed can be used instead of the standard maps stored in the memory on the carrying out of the function “automatic digging”.

An adaptive method is hereby provided which takes account of the changing material properties by modification of the automatic lift and tilt command signals and thereby substantially differs from known “teach-in” systems for automatic bucket filling.

1. Work machine, preferably a wheeled loader, having a bucket which is movable via lifting arms having at least one lift cylinder, pivotable via a tilt mechanism actuable via at least one tilt cylinder, having a selectable fully automatic or semi-automatic bucket filling process in which the bucket is movable by a superimposition of the tilt movement of the bucket and lift movement of the lifting arm for filling, wherein
material-dependent target tilt cylinder speed values and target lift cylinder speed values stored in a memory are associated with the measured lift cylinder pressure values and/or the pulling force for the regulation of the bucket filling process.

2. A work machine in accordance with claim 1, wherein the material-dependent target tilt cylinder speed values and target lift cylinder speed values can be determined as specific loading characteristics directly on site and can be stored in the memory as a characteristic map or as a function derived therefrom.

3. A work machine in accordance with claim 1, wherein the material-dependent target tilt cylinder speed values and target lift cylinder speed values can be stored in the memory after a standardized determination as a standard characteristic map or function derived therefrom.

4. A work machine in accordance with claim 1, wherein the start of the bucket filling process can be determined by monitoring the lift cylinder pressure or its change over time.

5. A work machine in accordance with claim 1, wherein the occurrence of inhomogeneity, for example a rough stone in the excavated material, which does not permit a continuation of the standard routine for the successful filling of the bucket, is recognized and triggers a routine adapted to the situation, which permits a successful filling of the bucket.

6. A work machine in accordance with claim 1, wherein the end of the bucket filling process can be determined by monitoring the lift cylinder pressure or its change over time.

7. A work machine in accordance with claim 6, wherein an automatic clamping of the filled bucket to the abutment is provided as the final measure of the automated bucket filling process.

8. A work machine in accordance with claim 1, wherein the manual lift and tilt cylinder command setting and the manual pulling force setting can be overridden automatically for the power-optimized utilization of the hydraulic components on a semi-automatic bucket filling process.

9. A work machine in accordance with claim 1, wherein the automatically generated lift and tilt cylinder command settings can be overridden by manual lift and tilt cylinder command settings on the fully automatic bucket filling process and, optionally, the automatic pulling force setting can be manually overridden.

10. A work machine in accordance with claim 1, wherein it has at least one sensor with which the material structure of the excavated material can be determined.

11. A work machine in accordance with claim 10, wherein at least one sensor from the following group of sensors is installed as the sensor: sonar sensor, radar sensor, active or passive infrared sensor, laser sensor, stereo vision camera.

12. A work machine in accordance with claim 2, wherein the material-dependent target tilt cylinder speed values and target lift cylinder speed values can be stored in the memory after a standardized determination as a standard characteristic map or function derived therefrom.

13. A work machine in accordance with claim 12, wherein the start of the bucket filling process can be determined by monitoring the lift cylinder pressure or its change over time.

14. A work machine in accordance with claim 2, wherein the start of the bucket filling process can be determined by monitoring the lift cylinder pressure or its change over time.

15. A work machine in accordance with claim 3, wherein the start of the bucket filling process can be determined by monitoring the lift cylinder pressure or its change over time.

16. A work machine in accordance with claim 15, wherein the occurrence of inhomogeneity, for example a rough stone in the excavated material, which does not permit a continuation of the standard routine for the successful filling of the bucket, is recognized and triggers a routine adapted to the situation, which permits a successful filling of the bucket.

17. A work machine in accordance with claim 14, wherein the occurrence of inhomogeneity, for example a rough stone in the excavated material, which does not permit a continuation of the standard routine for the successful filling of the bucket, is recognized and triggers a routine adapted to the situation, which permits a successful filling of the bucket.

18. A work machine in accordance with claim 13, wherein the occurrence of inhomogeneity, for example a rough stone in the excavated material, which does not permit a continuation of the standard routine for the successful filling of the bucket, is recognized and triggers a routine adapted to the situation, which permits a successful filling of the bucket.

19. A work machine in accordance with claim 12, wherein the occurrence of inhomogeneity, for example a rough stone in the excavated material, which does not permit a continuation of the standard routine for the successful filling of the bucket, is recognized and triggers a routine adapted to the situation, which permits a successful filling of the bucket.

20. A work machine in accordance with claim 4, wherein the occurrence of inhomogeneity, for example a rough stone in the excavated material, which does not permit a continuation of the standard routine for the successful filling of the bucket, is recognized and triggers a routine adapted to the situation, which permits a successful filling of the bucket.
